(19) United States
(12) Patent Application Publication
(10) Pub. No.: US 2006/0045559 A1
(43) Pub. Date: Mar. 2, 2006

(54) Method of actuating a cleaning system and a printing machine including the same

(75) Inventor: Michael F. Zona, Holley, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/930,177

(22) Filed: Aug. 31, 2004

(51) Int. Cl. G03G 15/02

(52) U.S. Cl. 399/100

(57) ABSTRACT

A printing machine comprises a charging device. The charging device comprises a coronode and a control grid. An included power supply supplies a coronode voltage to the coronode. Under control of the grid, the coronode generates ions which flow towards an included photosensitive surface. The printing machine includes a cleaning system which cleans the coronode and grid. The cleaning system is actuated based on an included method. The method comprises monitoring the coronode voltage, providing a predetermined threshold value, and determining that cleaning is needed based on when the coronode voltage equals the threshold value. Upon determining that cleaning is needed, the cleaning system is actuated or scheduled. Optionally, a cleaning message is sent to a user, operator or maintenance person who, in turn, actuates or schedules the cleaning system.

### INCORPORATION BY REFERENCE OF ANOTHER U.S. PATENT

The disclosure of U.S. Pat. No. 6,711,363 to William H. Wayman, entitled “Method of determining a charging device pre-fault status, a printing machine arranged with the same method, a method of forming a charging device service message and a method of triggering a cleaning cycle”, issued 23 Mar. 2004, is hereby incorporated by reference being verbatim and with the same effect as though the same disclosure of such patent were fully and completely set forth herein, it being noted that such patent is assigned to Xerox Corporation, the same assignee as in the instant application.

### BACKGROUND OF THE INVENTION

Charging device contamination is a common problem in xerographic printing machines. See, for example, the discussion of charging device contamination at col. 1, lines 17-41 of the aforementioned patent U.S. Pat. No. 6,711,363 to William H. Wayman.

It is known that cleaning the grid and coronode components in a scorotron or corotron of a charging device increases the charging device's usable life and thereby decreases the device's running cost.

As known, the generation of corona in a charging device results in dysfunctional outputs that must be either eliminated or accommodated. The most common dysfunctional output is the generation of ozone, which is typically controlled from the environment using an activated charcoal filter or similar filtering technique. Another dysfunctional output is the generation of nitrous oxides that tend to leach into the photoreceptor materials and cause deletions or haziness in the final output.

To prevent these oxides from damaging the photoreceptor, an Acheson Colloids or “DAG” coating is applied to the grid and/or shield components, which tends to hold and dilute the oxides prior to causing any damage. Airflow in and around the corona device also helps to limit the damage due to nitrous oxides.

Another major dysfunctional output is the formation of dendritic silicates that form on and around the points of corona generation. These growths can be due to the small amounts of silicone vapor in the customer environment, but more often occurs when silicone based fuser oils are used by the fusing subsystem in the machine. The silicone-ridden air is cycled throughout the ducting in the machine and eventually enters the corona device to undergo a chemical reaction in the plasma of the corona, which generates hard finger-like growths of silica on the both the grid and coronode components. These growths cause non-uniform corona generation, thereby causing non-uniform customer output.

If the charging device is cleaned frequently, these growths can be scraped from the components with cleaning devices or cleaning systems that contain brush or foam material, returning the uniformity of the device to nearly new condition. After some time, these growths cannot be removed using typical cleaning devices causing the device to require replacement. However, if the cleaning device is scrubbed against the components too often, the DAG coating material can get abraded from the grid and/or shields, which lead to nitrous oxide issues, or else can lead to corrosion of the metal underneath the DAG coating. The cleaner materials themselves can also wear and abrade if cleaner actuation is performed to often. It is therefore necessary to balance the frequency of the cleaning process to maintain uniformity of the device, while preventing the removal of coatings from the device's components.

The cleaning strategies commonly used for corona devices comprise automatic and manual modes. In automatic mode, an actuator is attached to the cleaning mechanism that enables cleaning of the device without any intervention from the customer. In manual mode, the customer or service technician must physically actuate the cleaning system. The choice in cleaner strategy is driven by the market placement of the machine. In graphic arts or production markets, the automatic cleaner is implemented because customers are willing to spend more for improved reliability. In the office market, manual cleaners are more typical due to the focus on reduced unit manufacturing cost (“UMC”) of the machine or xerographic cartridges. The problem with the manual method of corona device maintenance is that the customer typically only actuates the cleaning mechanism when the output of the machine is objectionable. At this point, the silica and contamination buildup has had a chance to become adhered well to the device surfaces and cleaning becomes not as effective. For optimal performance, the cleaner should be actuated long before problems are seen on the output. The question in the manual method becomes: When should the cleaning system be actuated?

As a result, there is a need for a method of actuating a cleaning system in a printing machine.

### SUMMARY OF THE INVENTION

In a first aspect of the invention, there is described a method of actuating a cleaning system in a printing machine, the printing machine comprising a charging device, the charging device comprising a coronode and a grid, the printing machine including a power supply arranged to provide a coronode voltage to the coronode, the printing machine including a cleaning system arranged to clean any of the coronode and grid, the printing machine arranged to actuate the cleaning system based on the method, the method comprising monitoring the coronode voltage, providing a predetermined threshold value, and determining that cleaning is needed based on when the coronode voltage equals the threshold value.

In a second aspect of the invention, there is described a printing machine comprising a charging device, the charging device comprising a coronode and a grid, the printing machine including a power supply arranged to provide a coronode voltage to the coronode, the printing machine including a cleaning system arranged to clean any of the coronode and grid, the printing machine arranged to actuate the cleaning system based on an included method, the method comprising monitoring the coronode voltage, providing a predetermined threshold value, and determining that cleaning is needed based on when the coronode voltage equals the threshold value.

### BRIEF DESCRIPTION OF THE SEVERAL VIEWS OF THE DRAWING

FIG. 1 depicts a printing machine 100 comprising a charging device 10. The charging device 10 comprises a coronode 11 and a grid 13. A cleaning device or cleaning system 90 is provided to clean the coronode 11 and grid 13. The cleaning system 90 is actuated based on an included method or process 200. An optional display unit 9a, internet communication network 9b, or wireless or radio frequency (“RF”) communication network 9c is provided to transmit a cleaning message 8.

FIG. 2 depicts one embodiment of a flow diagram of the cleaning system actuating method or process 200.

### DETAILED DESCRIPTION OF THE INVENTION

Briefly, a printing machine comprises a charging device. The charging device comprises a coronode and a control grid. An included power supply supplies a coronode voltage to the coronode. Under control of the grid, the coronode generates ions which flow towards an included photosensitive surface. The printing machine includes a cleaning system which cleans the coronode and grid. The cleaning system is actuated based on an included method. The method comprises monitoring the coronode voltage, providing a predetermined threshold value, and determining that cleaning is needed based on when the coronode voltage equals the threshold value. Upon determining that cleaning is needed, the cleaning system is actuated or scheduled. Optionally, a cleaning message is sent to a user, operator or maintenance person who, in turn, actuates or schedules the cleaning system.

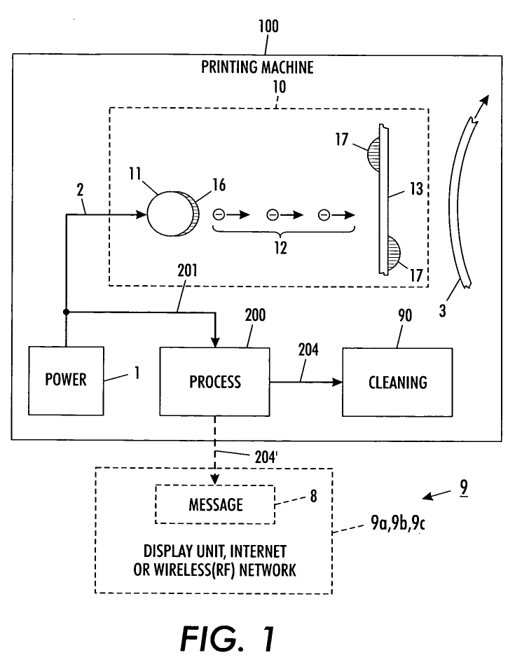

Referring now to FIG. 1, there is depicted a printing machine 100. The printing device 100 comprises a charging device 10.

In one embodiment, the charging device 10 comprises a corotron.

In one embodiment, the charging device 10 comprises a scorotron.

As shown, the charging device 10 comprises a coronode 11 and a grid 13. An included power supply 1 supplies a coronode voltage 2 to the coronode 11.

In one embodiment, the coronode 11 comprises a wire.

In one embodiment, the coronode 11 comprises a pin array.

Still referring to FIG. 1, the coronode 11 acts under control of the grid 13 to generate charged ions 12. Once generated, the charged ions 12 flow towards an included photosensitive surface 3, as shown.

The corona-generation process causes contamination matter 16 and 17 to become disposed on the coronode 11 and grid 13, respectively. As shown, a cleaning system 90 is provided to clean any of the coronode 11 and grid 13. Thus, when actuated, the cleaning system 90 acts to reduce any of the contamination matter 16 and 17.

In one embodiment, the cleaning system 90 cleans the coronode 11.

In one embodiment, the cleaning system 90 cleans the grid 13.

In one embodiment, the cleaning system 90 cleans the coronode 11 and the grid 13.

As shown in FIG. 1, the printing machine 100 is arranged to actuate 204 the cleaning system 90 based on an included method or process 200.

In one embodiment, the printing machine 100 is coupled to an optional display unit 9a, internet communication network 9b, or wireless or RF communication network 9c, the foregoing items 9a, 9b and 9c being collectively depicted as reference number 9. As shown, the display unit, internet communication network, or wireless or RF communication network 9, in turn, is arranged for communicating or sending 204′ an optional cleaning message 8 to a user, operator or maintenance person.

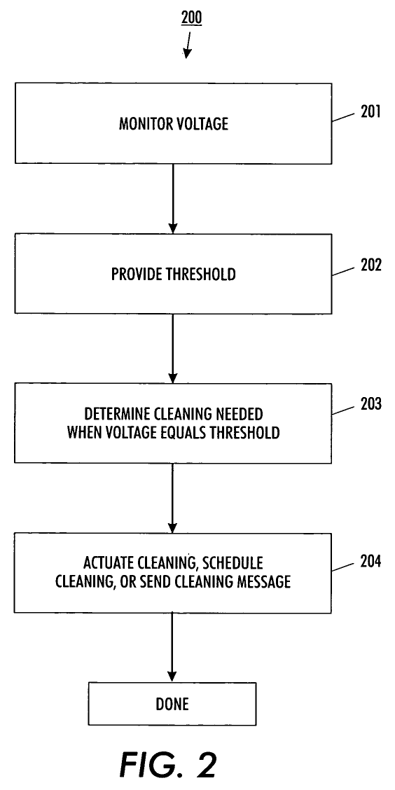

Referring now to FIG. 2, there is shown one embodiment of a flow diagram of the method or process 200. As shown, the process 200 comprises the plurality of steps designated 201 through 204. The process starts with step 201.

In step 201, the process monitors the coronode voltage 2. The process then goes to step 202.

In step 202, the process provides a predetermined threshold value. In one embodiment, the threshold value is substantially from negative seven thousand (−7,000) to negative nine thousand (−9,000) volts. The process then goes to step 203.

In step 203, the process compares the coronode voltage 2 to the predetermined threshold value and determines that cleaning is needed when the coronode voltage 2 equals the predetermined threshold value. The process then goes to step 204.

In step 204, the process performs any of the following acts: the process actuates the cleaning system 90, the process schedules the actuation of the cleaning system 90, and the process sends a cleaning message 8 to a printing machine user, operator or maintenance person.

Some possible variations of step 204 are now described.

In one embodiment, step 204 actuates the cleaning system 90 a plurality (N) of times, where N equals an integer equal to or greater than 2, hence N equals 2, 3, 4, etc.

In one embodiment, step 204 includes a step of actuating the cleaning system 90 substantially immediately.

In one embodiment, step 204 includes a step of scheduling the next actuation of the cleaning system 90 at the next convenient time, such as next standby mode, fuser warm-up, or power down.

In one embodiment, step 204 includes a step of sending the cleaning message 8 to a user, operator or maintenance person associated with the printing machine 100. For example, in one embodiment the cleaning message 8 indicates that cleaning is needed. In this latter embodiment, in response to receiving the cleaning message 8, the user, operator or maintenance person actuates the cleaning system 90 or else schedules the actuation of the cleaning system 90.

Referring now to FIG. 1, this optional step of sending the cleaning message 8 to a user, operator or maintenance person is depicted by the reference number 204′.

Referring still to FIG. 1, in one embodiment the cleaning message 8 is sent to the user, operator or maintenance person by means of an included display unit depicted as reference number 9a. For example, in one embodiment the display unit 9a visually informs the user, operator or maintenance person that cleaning is needed.

In one embodiment, the cleaning message 8 is sent to the user, operator or maintenance person by means of an included internet communication network depicted as reference number 9b. For example, in one embodiment an e-mail message 8 is transmitted over the internet communication network 9b to advise or alert the user, operator or maintenance person that cleaning is needed.

In one embodiment, the cleaning message 8 is sent to the user, operator or maintenance person by means of an included wireless or RF communication network depicted as reference number 9c. For example, in one embodiment the wireless or RF communication network 9c comprises a cellular telephone network which transmits a text message 8 to communicate to the user, operator or maintenance person that cleaning is needed.

Referring now generally to FIG. 1, in one embodiment the printing machine 100 comprises a network printer.

In one embodiment, the printing machine 100 comprises a copier.

In one embodiment, the printing machine 100 comprises a facsimile device.

Thus, the present invention uses the pin voltage monitor signal 2 on the high voltage power supply 1 as a signal to detect when the charging device cleaning system should be activated. Moreover, it is proposed to use process control algorithms to monitor the coronode voltage analog monitor from the corona device's high voltage power supply. As the silica growth and other contamination build up on the grid and coronode components, the high voltage power supply increases the direct coupled (“DC”) voltage to the coronode in order to maintain a constant DC current. When the analog monitor for the pin's DC voltage reaches a predetermined threshold level, a signal is generated to process control that indicates that the cleaning system 90 needs to be actuated at the next convenient time, that is, next standby mode, fuser warm-up, power down, etc.

Moreover, this invention provides a method of determining when the cleaning mechanism should be actuated.

In one embodiment, the analog pin voltage that the high voltage corona supply provides over a 30-hour period using a pin device exposed in an environment containing silicone oil in high humidity conditions is monitored. In this case the device needed roughly 8 kV at the start of the test in order to maintain constant corona current of 2100 micro Amps. As the device becomes contaminated over time, the DC pin voltage increases to maintain the corona current. The rise can reach a point to cause the device to reach its arcing limit or max-out the available power from the high voltage supply itself. However, using a threshold trigger of 9 kV at the pins, the invention activates the cleaning system three (3) times over the pins and grid. As a result, the required DC voltage to the pins nearly returns to the original operating voltage each time the cleaner is actuates. This results in a flatter pin voltage profile over the life of the pin device and prevents the device from reaching its arcing limit or preventing the supply from over-heating.

The typical known strategy for automatic cleaners is to actuate them at every power-up or every fixed number (“n”) of prints. As mentioned in the “background” section above, this method can cause the actuation to be too excessive, which increases the amount of wear of the coatings on the coronode device surfaces. The typical known strategy for manual cleaning is to instruct the customer to use the cleaner when the prints/copies become objectionable. As stated earlier in the “background” section above, this leads to cleaning the device not frequently enough. In most cases, the contamination becomes uncleanable under these conditions.

In contrast to these typical known strategies, the present invention allows the cleaning of the device to be actuated only when necessary. As a result, the present invention prevents the increased wear rate of the coatings, but also implements enough preventive maintenance of the device to enable longer device life and reduced total cost of ownership. In automatic mode, process control can monitor the analog of the pin voltage being delivered by the supply in order to actuate the cleaner when the desired threshold (set via NVM value) has been reached. The same signal and threshold can be used in manual mode. In the manual case, a message is sent to the user interface when the threshold is met indicating to the customer that the device needs cleaning.

Thus, there has been described the first aspect of the invention, namely, the method 200 of actuating a cleaning system 90 in the printing machine 100, the printing machine 100 comprising a charging device 10, the charging device 10 comprising a coronode 11 and a grid 13, the printing machine including a power supply 1 arranged to provide a coronode voltage 2 to the coronode 11, the printing machine 100 including a cleaning system 90 arranged to clean any of the coronode 11 and grid 13, the printing machine 100 arranged to actuate the cleaning system 90 based on the method 200, the method 200 comprising a step 201 of monitoring the coronode voltage 2, a step 202 of providing a predetermined threshold value and a step 203 of determining that cleaning is needed based on when the coronode voltage 2 equals the threshold value.

In one embodiment, the cleaning system 90 is arranged to clean the coronode 11 and the grid 13.

In one embodiment, the method 200 includes a step 204 of actuating the cleaning system 90.

In one embodiment, the method 200 includes a step 204 of scheduling a next actuation of the cleaning system 90.

In one embodiment, the method 200 includes a step 204′ of sending a cleaning message 8.

In one embodiment, the cleaning message 8 is sent by means of an included display unit 9a.

In one embodiment, the cleaning message 8 is sent by means of an included internet communication network 9b.

In one embodiment, the cleaning message 8 is sent by means of an included wireless or radio frequency communication network 9c.

In one embodiment, the charging device 10 comprises a scorotron.

In one embodiment, the charging device 10 comprises a corotron.

In one embodiment, the coronode comprises a wire.

In one embodiment, the coronode comprises a pin array.

In one embodiment, the threshold value is substantially from negative seven thousand (−7,000) to negative nine thousand (−9,000) volts.

Also, there has been described the second aspect of the invention, namely, the printing machine 100 comprising a charging device 10, the charging device 10 comprising a coronode 11 and a grid 13, the printing machine including a power supply 1 arranged to provide a coronode voltage 2 to the coronode 11, the printing machine 100 including a cleaning system 90 arranged to clean any of the coronode 11 and grid 13, the printing machine 100 arranged to actuate the cleaning system 90 based on the included method 200, the method 200 comprising a step 201 of monitoring the coronode voltage 2, a step 202 of providing a predetermined threshold value and a step 203 of determining that cleaning is needed based on when the coronode voltage 2 equals the threshold value.

The table below lists the drawing element reference numbers together with their corresponding written description:

Ref. No.: Description:

1 power supply
2 coronode voltage
3 photosensitive surface
8 cleaning message
9a display unit
9b internet communication network
9c wireless or radio frequency communication network
9 any of 9a, 9b and 9c
10 charging device
11 coronode
12 ions
13 grid
16 contamination matter disposed on coronode
17 contamination matter disposed on grid
90 cleaning system
100 printing machine (network printer, copier, facsimile device)
200 cleaning system actuating method
201 monitor voltage
202 provide threshold
203 determining cleaning is needed when the voltage equals the threshold
204 actuate cleaning, schedule cleaning, or send cleaning message
204′ send cleaning message

While various embodiments of a method of actuating a cleaning system and a printing machine including the same, in accordance with the present invention, are described above, the scope of the invention is defined by the following claims.

1. A method (200) of actuating a cleaning system (10), in a printing machine (100), the printing machine comprising a charging device (10), the charging device comprising a coronode (11) and a grid (13), the printing machine including a power supply (1) arranged to provide a coronode voltage (2) to the coronode, the printing machine including a cleaning system arranged to clean any of the coronode and grid, the printing machine arranged to actuate the cleaning system based on the method, the method comprising monitoring (201) the coronode voltage, providing (202) a predetermined threshold value, and determining (203) that cleaning is needed based on when the coronode voltage equals the threshold value.

2. The method (200) of claim 1, the cleaning system (90) arranged to clean both the coronode (11) and the grid (13).

3. The method (200) of claim 1, including a step (204) of actuating the cleaning system (90).

4. The method (200) of claim 1, including a step (204) of scheduling a next actuation of the cleaning system, (90).

5. The method (200) of claim 1, Including a step (204′) of sending a cleaning message (8).

6. The method (200) of claim 5, wherein the cleaning message (8) is sent (204′) by means of an included display unit (9a).

7. The method (200) of claim 5, wherein the cleaning message (8) is sent (204′) by means of an included internet communication network (9b).

8. The method (200) of claim 5, wherein the cleaning message (8) is sent (204′) by means of an included wireless or radio frequency communication network (9c).

9. The method (200) of claim 1, wherein the charging device (10) comprises any of a scorotron and a corotron.

10. (canceled)

11. The method (200) of claim 1, wherein the coronode (11) comprises any of a wire and a pin array.

12-13. (canceled)

14. A printing machine (100) comprising a charging device (10), the charging device comprising a coronode (11) and a grid (13), the printing machine including a power supply (1) arranged to provide a coronode voltage (2) to the coronode, the printing machine including a cleaning system (90) arranged to clean any of the coronode and grid, the printing machine arranged to actuate the cleaning system based on an included method (200), the method comprising monitoring (201) the coronode voltage, providing (202) a predetermined threshold value, and determining (203) that cleaning is needed based on when the coronode voltage equals the threshold value.

15. (canceled)

16. The printing machine (100) of claim 14, the method (200) including a step (204) of actuating the cleaning system (90).

17. The printing machine (100) of claim 14, the method (200) including a step (204) of scheduling a next actuation of the cleaning system (90).

18. The printing machine of claim 14, the method (200) including a step (204′) of sending a cleaning message (8).

19. The printing machine (100) of claim 18, wherein the cleaning message (8) is sent (204′) by means of an included display unit (9a).

20. The printing machine (100) of claim 18, wherein the cleaning message (8) is sent (204′) by means of an included internet communication network (9b).

21. The printing machine (100) of claim 18, wherein the cleaning message (8) is sent (204′) by means of an included wireless or radio frequency communication network (9c).

22. The printing machine (100) of claim 14, wherein the charging device (10) comprises any of a scorotron and a corotron.

23. (canceled)

24. The printing machine (100) of claim 14, wherein the coronode (11) comprises any of a wire and a pin array.

25. (canceled)

26. The printing machine (100) of claim 14, wherein the threshold value is substantially from negative seven thousand (−7,000) to negative nine thousand (−9,000) volts.

27. The printing machine (100) of claim 14, comprising a network printer.

28. The printing machine (100) of claim 14, comprising a copier.

29. The printing machine (100) of claim 14, comprising a facsimile device.

30. The method (200) of claim 3, the cleaning system (90) actuating (204) thus preventing the coronode voltage (2) from reaching its arcing limit or preventing the power supply (1) from over-heating.

31. The method (200) of claim 5, the cleaning message (8) being sent (204′) to the user, operator or maintenance person associated with the printing machine (100).

32. The method (200) of claim 31, the cleaning message (8) indicating that cleaning is needed.

33. The printing machine (100) of claim 16, the cleaning system (90) being activated a plurality (N) of times, where N equals an integer equal to or greater than 2.

34. The printing machine (100) of claim 17, the next actuation of the cleaning system (90) being scheduled (204) at a next convenient time or event, such as the next standby mode, fuser warm-up or power down.

35. The printing machine (100) of claim 18, the cleaning message (8) being sent (204′) to the user, operator or maintenance person associated with the printing machine (100).
